(19) United States
(12) Patent Application Publication
(10) Pub. No.: US 2023/0169100 A1
(43) Pub. Date: Jun. 1, 2023

(54) METHOD AND APPARATUS FOR INFORMATION ACQUISITION, ELECTRONIC DEVICE, AND COMPUTER-READABLE STORAGE MEDIUM

(71) Applicant: BOE Technology Group Co., Ltd., Beijing (CN)

(72) Inventor: Bingqian WANG, Beijing (CN)

(21) Appl. No.: 17/425,045

(22) PCT Filed: Jan. 28, 2021
(86) PCT No.: PCT/CN2021/074046

§ 371 Date: Jul. 22, 2021

(30) Foreign Application Priority Data
Feb. 26, 2020 (CN) 202010121474.7

(51) Int. Cl. G06F 16/332; G06F 16/33; G06F 16/31

(52) U.S. Cl. CPC G06F 16/3329; G06F 16/3344; G06F 16/316

(57) ABSTRACT

The present disclosure relates to the field of natural language processing technologies, and more particularly, to a method and an apparatus for information acquisition, an electronic device, and a computer-readable storage medium. The method includes: recognizing at least one entity retrieval word in a to-be-answered question; performing information retrieval according to the at least one entity retrieval word to obtain a retrieval text in a sub-graph form corresponding to the at least one entity retrieval word; determining a retrieval text in a target sub-graph form by matching the retrieval text in the sub-graph form with the to-be-answered question; and determining a target answer to the to-be-answered question according to the retrieval text in the target sub-graph form.

### CROSSREFERENCE TO RELATED APPLICATION

The present disclosure claims priority to Chinese Patent Application No. 202010121474.7 titled “METHOD AND APPARATUS FOR INFORMATION ACQUISITION, ELECTRONIC DEVICE, AND COMPUTER-READABLE STORAGE MEDIUM” and filed to the State Patent Intellectual Property Office on Feb. 26, 2020, the entire contents of which are incorporated herein by reference.

### TECHNICAL FIELD

The present disclosure relates to the field of natural language processing technologies, and more particularly, to a method and an apparatus for information acquisition, an electronic device, and a computer-readable storage medium.

### BACKGROUND

A question answering system is one of the current research hotspots in natural language processing. An important step in the question answering system is an entity linking of a question sentence. An entity linking result has a direct impact on performance of the question answering system.

A traditional question entity connection method is mainly completed by means of two steps, i.e., by means of entity recognition and entity connection. Currently, the entity recognition is mainly based on Conditional Random Field (CRF) or Bidirectional Long Short-term Memory CRF (BLSTM CRF) and so on. The entity linking mainly adopts classification methods and similarity calculation methods, etc. In the classification methods, it is needed to select candidate entities first, and classic machine learning methods or neural network methods are employed for classification.

In terms of similarity calculation, there are methods such as probabilistic topic models, graph-based methods, and ranking methods. In general technical solutions, some of the technical solutions adopt word embedding-based methods to achieve entity linking, and in some other technical solutions, question understanding is implemented by means of template construction.

### SUMMARY

The present disclosure provides a method and an apparatus for information acquisition, an electronic device, and a computer-readable storage medium, to solve problems, in the related technologies, of consuming time and labor, lacking flexibility and being weaker in extensibility because a lot of artificial templates are required.

To solve the above problems, the present disclosure provides a method for information acquisition, which includes:

recognizing at least one entity retrieval word in a to-be-answered question;

performing information retrieval according to the at least one entity retrieval word to obtain a retrieval text in a sub-graph form corresponding to the at least one entity retrieval word;

determining a retrieval text in a target sub-graph form by matching the retrieval text in the sub-graph form with the to-be-answered question; and

determining a target answer to the to-be-answered question according to the retrieval text in the target sub-graph form.

Optionally, the determining a target answer to the to-be-answered question according to the retrieval text in the target sub-graph form includes:

determining at least one candidate answer corresponding to the to-be-answered question according to the retrieval text in the target sub-graph form;

obtaining a similarity between the at least one candidate answer and the to-be-answered question; and

determining the target answer to the to-be-answered question from the at least one candidate answer according to the similarity.

Optionally, the recognizing at least one entity retrieval word in a to-be-answered question includes:

obtaining the to-be-answered question;

inputting the to-be-answered question into a first network model for text recognition;

determining starting and ending positions of the to-be-answered question according to a text recognition result; and

determining the at least one entity retrieval word according to the starting and ending positions.

Optionally, the performing information retrieval according to the at least one entity retrieval word to obtain a retrieval text in a sub-graph form corresponding to the at least one entity retrieval word includes:

retrieving from a preset knowledge base by means of the at least one entity retrieval word to obtain a plurality of initial retrieval texts associated with the at least one entity retrieval word; and

associating the at least one entity retrieval word with the plurality of initial retrieval texts in the form of sub-graph to obtain the retrieval text in the sub-graph form.

Optionally, the determining a retrieval text in a target sub-graph form by matching the retrieval text in the sub-graph form with the to-be-answered question includes:

composing the retrieval text in the sub-graph form and the to-be-answered question into a sentence pair text;

inputting the sentence pair text into a second network model; and

performing entity disambiguation on the sentence pair text by means of the second network model to determine the retrieval text in the target sub-graph form.

Optionally, the determining at least one candidate answer corresponding to the to-be-answered question according to the retrieval text in the target sub-graph form includes:

disassembling the retrieval text in the target sub-graph form to obtain the at least one candidate answer.

Optionally, the obtaining a similarity between the at least one candidate answer and the to-be-answered question includes:

inputting the at least one candidate answer and the to-be-answered question into a third network model; and

performing similarity matching on the at least one candidate answer and the to-be-answered question by means of the third network model to determine the similarity between the at least one candidate answer and the to-be-answered question.

Optionally, the obtaining a similarity between the at least one candidate answer and the to-be-answered question includes:

inputting the at least one candidate answer and the to-be-answered question into a cosine similarity calculation model; and

performing similarity matching on the at least one candidate answer and the to-be-answered question by means of the cosine similarity calculation model to determine the similarity between the at least one candidate answer and the to-be-answered question.

Optionally, the determining the target answer to the to-be-answered question from the at least one candidate answer according to the similarity includes:

comparing the similarity with a preset similarity threshold; and

obtaining, form the at least one candidate answer, an answer where the similarity is greater than the similarity threshold, and determining the answer as the target answer.

To solve the above problems, the present disclosure provides an apparatus for information acquisition, which includes:

an entity retrieval word recognizing module, configured to recognize at least one entity retrieval word in a to-be-answered question;

a sub-graph retrieval text obtaining module, configured to perform information retrieval according to the at least one entity retrieval word to obtain a retrieval text in a sub-graph form corresponding to the at least one entity retrieval word;

a target sub-graph text determining module, configured to determine a retrieval text in a target sub-graph form by matching the retrieval text in the sub-graph form with the to-be-answered question; and

a target answer determining module, configured to determine a target answer to the to-be-answered question according to the retrieval text in the target sub-graph form.

Optionally, the target answer determining module includes:

a candidate answer determining unit, configured to determine at least one candidate answer corresponding to the to-be-answered question according to the retrieval text in the target sub-graph form;

a similarity obtaining unit, configured to obtain a similarity between the at least one candidate answer and the to-be-answered question; and

a target answer determining unit, configured to determine the target answer to the to-be-answered question from the at least one candidate answer according to the similarity.

Optionally, the entity retrieval word recognizing module includes:

a to-be-answered question obtaining unit, configured to obtain the to-be-answered question;

a text recognizing unit, configured to input the to-be-answered question into a first network model for text recognition;

a starting and ending positions determining unit, configured to determine starting and ending positions of the to-be-answered question according to a text recognition result; and

an entity retrieval word determining unit, configured to determine the at least one entity retrieval word according to the starting and ending positions.

Optionally, the sub-graph retrieval text obtaining module includes:

an initial retrieval text obtaining unit, configured to obtain a plurality of initial retrieval texts associated with the at least one entity retrieval word by retrieving from a preset knowledge base by means of the at least one entity retrieval word; and

a sub-graph retrieval text obtaining unit, configured to obtain the retrieval text in the sub-graph form by associating the at least one entity retrieval word with the plurality of initial retrieval texts in the form of sub-graph.

Optionally, the target sub-graph text determining module includes:

a sentence pair text composing unit, configured to compose the retrieval text in the sub-graph form and the to-be-answered question into a sentence pair text;

a sentence pair text inputting unit, configured to input the sentence pair text into a second network model; and

a target sub-graph text determining unit, configured to determine the retrieval text in the target sub-graph form by performing entity disambiguation on the sentence pair text by means of the second network model.

Optionally, the candidate answer determining unit includes:

a candidate answer obtaining subunit, configured to obtain the at least one candidate answer by disassembling the retrieval text in the target sub-graph form.

Optionally, the similarity obtaining unit includes:

a first candidate answer inputting subunit, configured to input the at least one candidate answer and the to-be-answered question into a third network model; and

a first similarity determining subunit, configured to determine the similarity between the at least one candidate answer and the to-be-answered question by performing similarity matching on the at least one candidate answer and the to-be-answered question by means of the third network model.

Optionally, the similarity obtaining unit includes:

a second candidate answer inputting subunit, configured to input the at least one candidate answer and the to-be-answered question into a cosine similarity calculation model; and

a second similarity determining subunit, configured to determine the similarity between the at least one candidate answer and the to-be-answered question by performing similarity matching on the at least one candidate answer and the to-be-answered question by means of the cosine similarity calculation model.

Optionally, the target answer determining unit includes:

a similarity comparison subunit, configured to compare the similarity with a preset similarity threshold; and

a target answer obtaining subunit, configured to obtain, form the at least one candidate answer, an answer where the similarity is greater than the similarity threshold, and to determine the answer as the target answer.

To solve the above problems, the present disclosure provides an electronic device, which includes:

a processor, a memory, and a computer program stored in the memory and executed by the processor. The computer program is executable by the processor, whereby any one of the above methods for information acquisition is implemented.

To solve the above problems, the present disclosure provides a nonvolatile computer-readable storage medium. Instructions in the storage medium are executable by a processor of an electronic device, whereby the electronic device is configured to perform any one of the above methods for information acquisition.

To solve the above problems, the present disclosure provides a computer program product, which includes a computer-readable code. When the computer-readable code runs on an electronic device, the electronic device is caused to perform any one of the above methods for information acquisition.

The above description is merely an overview of the technical solutions of the present disclosure. In order to more apparently understand the technical means of the present disclosure to implement in accordance with the contents of specification, and to more readily understand above and other objectives, features and advantages of the present disclosure, specific embodiments of the present disclosure are provided hereinafter.

### BRIEF DESCRIPTION OF THE DRAWINGS

To describe the technical solutions of the embodiments of the present disclosure or those of the related technologies more clearly, the accompanying drawings required for describing the embodiments or the related technologies will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 illustrates a flowchart of steps of a method for information acquisition according to an embodiment of the present disclosure;

FIG. 2 illustrates a flowchart of steps of another method for information acquisition according to an embodiment of the present disclosure;

FIG. 3 illustrates a schematic diagram of a question answering system according to an embodiment of the present disclosure;

FIG. 4 illustrates a schematic diagram of an entity tagging sample according to an embodiment of the present disclosure;

FIG. 5 illustrates a schematic diagram of an entity recognition model according to an embodiment of the present disclosure;

FIG. 6 illustrates a schematic diagram of entity sub-graph information according to an embodiment of the present disclosure;

FIG. 7 illustrates a schematic diagram of a bert-based sub-graph matching algorithm according to an embodiment of the present disclosure;

FIG. 8 illustrates a schematic diagram of disassembling a sub-graph according to an embodiment of the present disclosure;

FIG. 9 illustrates a schematic diagram of text similarity matching according to an embodiment of the present disclosure;

FIG. 10 illustrates a schematic diagram of a joint learning model according to an embodiment of the present disclosure;

FIG. 11 illustrates a schematic structural diagram of an apparatus for information acquisition according to an embodiment of the present disclosure;

FIG. 12 illustrates a schematic structural diagram of another apparatus for information acquisition according to an embodiment of the present disclosure;

FIG. 13 schematically illustrates a block diagram of an electronic device for performing the method according to the present disclosure; and

FIG. 14 schematically illustrates a memory cell for maintaining or carrying a program code for implementing the method according to the present disclosure.

### DETAILED DESCRIPTION

Detailed description of the present disclosure will further be made with reference to drawings and embodiments in order to make the objectives, features and advantages of the present disclosure more apparent and lucid.

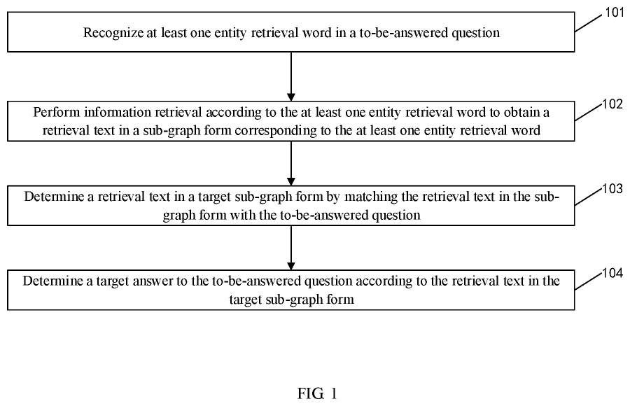

Referring to FIG. 1, a flowchart of steps of a method for information acquisition according to an embodiment of the present disclosure is illustrated. The method for information acquisition may include following steps.

Step 101: recognizing at least one entity retrieval word in a to-be-answered question.

The embodiments of the present disclosure may be applied to a question answering system to obtain a scene of an answer corresponding to the to-be-answered question.

The question answering system may be described as below with reference to FIG. 3.

With reference to FIG. 3, a schematic diagram of a question answering system according to an embodiment of the present disclosure is illustrated. As shown in FIG. 3, for a to-be-answered question “Q: In which year was Xu Beihong's Picture of Eight Horses created?”, entity recognition may be first performed on the to-be-answered question to obtain recognized entity retrieval words: “Xu Beihong” and “Picture of Eight Horses”. Next, by making information retrieval based on the two entity retrieval words, two retrieval results in a sub-graph form may be obtained as below: Picture of Eight Horses (Giuseppe Castiglione) and Picture of Eight Horses (Xu Beihong) (it is to be understood that all information in a knowledge graph is in the form of sub-graphs). Next, non-retrieved information is removed by performing entity disambiguation by means of sub-graph matching to obtain sub-graph information corresponding to the Picture of Eight Horses (Xu Beihong). The final answer is obtained by means of text similarity matching between entity information and the to-be-answered question.

Next, solutions of this embodiment of the present disclosure are described in detail with reference to specific steps.

The to-be-answered question refers to a question for obtaining the corresponding answer from the knowledge graph.

In some examples, the to-be-answered question may be a question inputted by a user. For example, when user A needs to obtain an answer to a certain question, the user A may input a corresponding question in the knowledge graph, such that the user A may obtain the corresponding to-be-answered question.

In some examples, the to-be-answered question may also be a question obtained from the Internet. For example, it may be obtained questions in which the user is interested, and a question in which the user is more interested is determined as the to-be-answered question.

It is to be understood that the above examples are merely examples enumerated for better understanding the technical solutions of this embodiment of the present disclosure. In specific implementation, other methods may be adopted to obtain the to-be-answered question. This embodiment of the present disclosure does not impose any restriction on the methods for obtaining the to-be-answered question.

The entity retrieval word refers to an entity word for performing information retrieval in the to-be-answered question. In the present disclosure, the entity retrieval word in the to-be-answered question may be obtained by means of pointer tagging. The methods for obtaining the entity retrieval word will be described in detail in following embodiments, which are not unnecessarily elaborated in this embodiment of the present disclosure.

After the to-be-answered question is obtained, the to-be-answered question may be recognized, to obtain at least one entity retrieval word contained in the to-be-answered question. For example, the to-be-answered question is: in which year was Xu Beihong's Picture of Eight Horses created, wherein the entities include: Xu Beihong, and Picture of Eight Horses.

It is to be understood that the above examples are merely examples enumerated for better understanding the technical solutions of this embodiment of the present disclosure, and are not intended to be the only limitation on this embodiment of the present disclosure.

Step 102 is performed after the at least one entity retrieval word in the to-be-answered question is recognized.

Step 102: performing information retrieval according to the at least one entity retrieval word to obtain a retrieval text in a sub-graph form corresponding to the at least one entity retrieval word.

The retrieval text in the sub-graph form refers to a retrieval result text obtained by performing information retrieval on the knowledge graph by means of the at least one entity retrieval word.

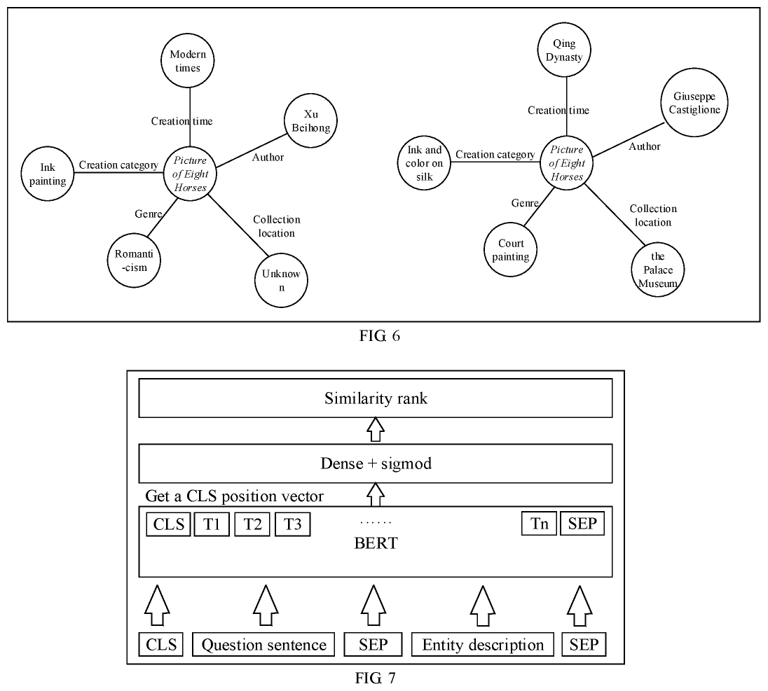

It is to be understood that in the knowledge graph, various types of information generally is in the form of sub-graph. The sub-graph form may be described with reference to FIG. 6. With reference to FIG. 6, a schematic diagram of entity sub-graph information according to an embodiment of the present disclosure is illustrated. As shown in FIG. 6, information related to the Picture of Eight Horses may be connected by means of “-”, such that corresponding associated information in the form of sub-graph may be formed.

After the at least one entity retrieval word in the to-be-answered question is recognized, information retrieval may be performed in the knowledge graph by means of the at least one entity retrieval word, and next, the retrieval text in the sub-graph form corresponding to each entity retrieval word may be obtained.

Step 103 is performed after the retrieval text in the sub-graph form corresponding to the at least one entity retrieval word is obtained by performing information retrieval according to the at least one entity retrieval word.

Step 103: determining a retrieval text in a target sub-graph form by matching the retrieval text in the sub-graph form with the to-be-answered question.

The retrieval text in the target sub-graph form refers to a retrieval text in the sub-graph form, selected from the at least one entity retrieval word, that matches the to-be-answered question. That is, in this step, entity disambiguation is implemented to remove the retrieval text in the sub-graph form that does not match the to-be-answered question, such that a final retrieval text matching the to-be-answered question may be obtained, which is the retrieval text in the target sub-graph form.

After the retrieval text in the sub-graph form corresponding to the at least one entity retrieval word is obtained, the retrieval text in the sub-graph form may be matched with the to-be-answered question, and based on the matching result, the retrieval text in the target sub-graph form matching the to-be-answered question may be determined from at least one entity retrieval word. Processes of matching and determining the retrieval text in the target sub-graph form will be described in detail in the following embodiments, which are not unnecessarily elaborated in this embodiment of the present disclosure.

Step 104 is performed after the retrieval text in the target sub-graph form is determined by matching the retrieval text in the sub-graph form with the to-be-answered question.

Step 104: determining a target answer to the to-be-answered question according to the retrieval text in the target sub-graph form.

The Step 104 may include following steps 104a, 104b, and 104c.

Step 104a: determining at least one candidate answer corresponding to the to-be-answered question according to the retrieval text in the target sub-graph form.

The candidate answer refers to a candidate item, selected from the retrieval text in the target sub-graph form, as an answer to the to-be-answered question.

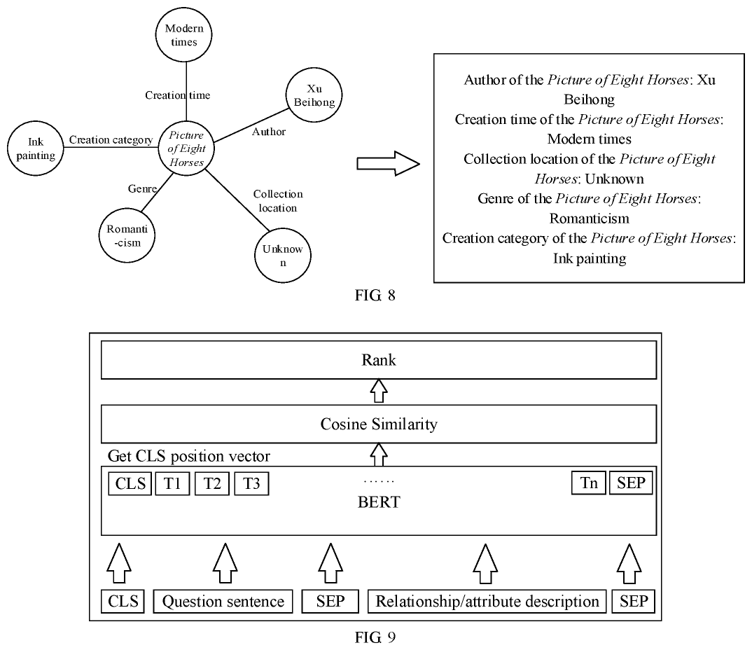

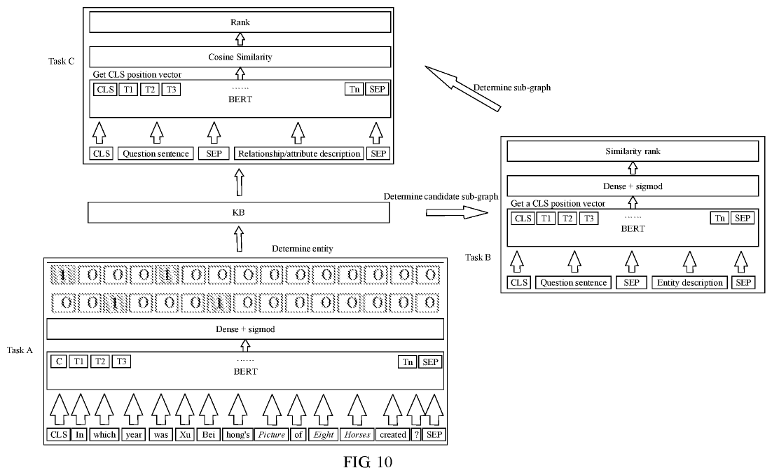

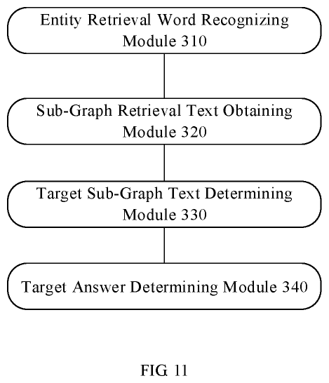

After the retrieval text in the target sub-graph form matching the to-be-answered question is obtained, the at least one candidate answer corresponding to the to-be-answered question may be determined according to the retrieval text in the target sub-graph form. Specifically, the at least one candidate answer may be obtained by disassembling the retrieval text in the target sub-graph form. For example, with reference to FIG. 8, a schematic diagram of disassembling a sub-graph according to an embodiment of the present disclosure is illustrated. As shown in FIG. 8, after the left figure of FIG. 8 is disassembled, a plurality of candidate items as shown in the right figure of FIG. 8 may be obtained as below: author of the Picture of Eight Horses: Xu Beihong, creation time of the Picture of Eight Horses: modern times, collection location of the Picture of Eight Horses: unknown, genre of the Picture of Eight Horses: romanticism, and creation category of the Picture of Eight Horses: ink painting, etc.

It is to be understood that the above examples are merely examples enumerated for better understanding the technical solutions of this embodiment of the present disclosure, and are not intended to be the only limitation on this embodiment of the present disclosure.

Step 104b is performed after the at least one candidate answer corresponding to the to-be-answered question is determined according to the retrieval text in the target sub-graph form.

Step 104b: obtaining a similarity between the at least one candidate answer and the to-be-answered question.

The similarity refers to degree of similarity between the at least one candidate answer and the to-be-answered question. The similarity can reflect which candidate answers are closer to the to-be-answered question, and those candidate answers closer to the to-be-answered question can be determined as standard answers to the to-be-answered question.

After the at least one candidate answer corresponding to the to-be-answered question is determined according to the retrieval text in the target sub-graph form, the similarity between the at least one candidate answer and the to-be-answered question may be obtained. Specifically, the at least one candidate answer and the to-be-answered question may be respectively inputted into a preset network model, and the similarity between the at least one candidate answer and the to-be-answered question is recognized by means of the preset network model. Specific processes of recognizing the similarity between at least one candidate answer and the to-be-answered question will be described in detail in the following embodiments, which are not unnecessarily elaborated in this embodiment of the present disclosure.

Step 104c is performed after the similarity between each candidate answer and the to-be-answered question is obtained.

Step 104c: determining a target answer to the to-be-answered question from the at least one candidate answer according to the similarity.

The target answer refers to the standard answer to the to-be-answered question selected from the at least one candidate answer. That is, the finally selected target answer is determined as an accurate answer to the to-be-answered question.

After the similarity between the at least one candidate answer and the to-be-answered question is obtained, the target answer to the to-be-answered question may be selected from the at least one candidate answer in combination with the similarity of the at least one candidate answer. Specifically, a candidate answer with the maximum similarity may be selected from the at least one candidate answer as the target answer to the to-be-answered question, or at least one candidate answer whose similarity is greater than a preset similarity threshold is selected from the at least one candidate answer as the target answer to the to-be-answered question. Specifically, the target answer to the to-be-answered question may be determined according to business requirements, which is not limited in this embodiment of the present disclosure.

In this embodiment of the present disclosure, entity disambiguation is performed by means of sub-graph matching, it is not required to construct templates, and thus information retrieval efficiency of the question answering system can be improved.

The method for information acquisition provided by an embodiment of the present disclosure includes: recognizing at least one entity retrieval word in a to-be-answered question; performing information retrieval according to the at least one entity retrieval word to obtain a retrieval text in a sub-graph form corresponding to the at least one entity retrieval word; determining a retrieval text in a target sub-graph form by matching the retrieval text in the sub-graph form with the to-be-answered question; and determining a target answer to the to-be-answered question according to the retrieval text in the target sub-graph form. In this embodiment of the present disclosure, entity disambiguation is performed by means of sub-graph matching, and simultaneously three key tasks are achieved, i.e., entity recognition, entity disambiguation, and text matching. This method neither requires introduction of external corpuses nor requires construction of templates, and thus flexibility and efficiency of the question answering system can be improved.

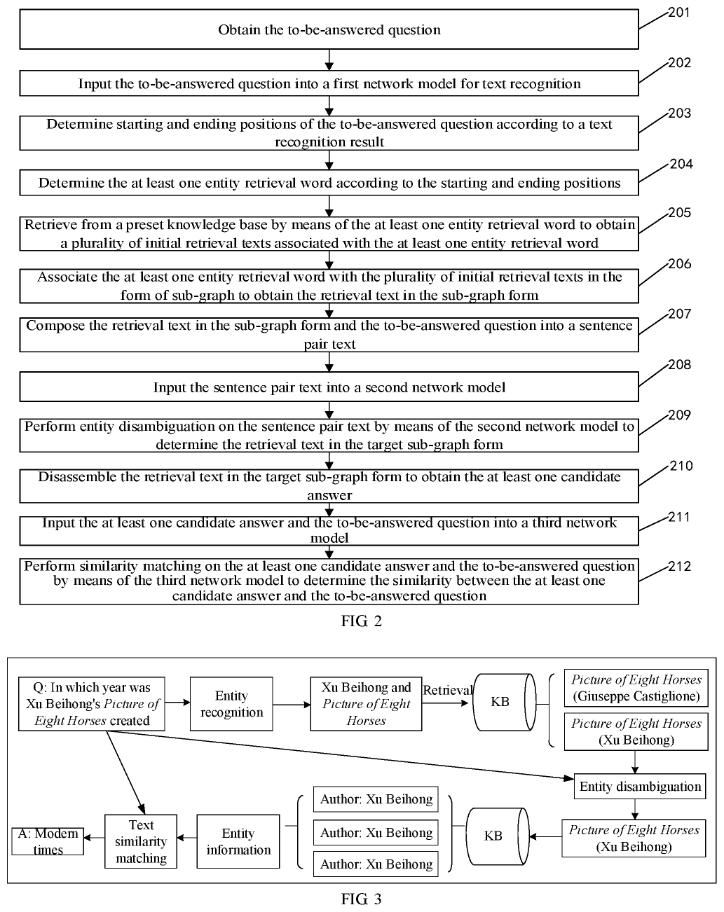

With reference to FIG. 2, a flowchart of steps of another method for information acquisition according to an embodiment of the present disclosure is illustrated. This method for information acquisition may include following steps.

Step 201: obtaining the to-be-answered question.

The embodiments of the present disclosure may be applied to a question answering system to obtain a scene of an answer corresponding to the to-be-answered question.

The question answering system may be described as below with reference to FIG. 3.

With reference to FIG. 3, a schematic diagram of a question answering system according to an embodiment of the present disclosure is illustrated. As shown in FIG. 3, for a to-be-answered question “Q: In which year was Xu Beihong's Picture of Eight Horses created?”, entity recognition may be first performed on the to-be-answered question to obtain recognized entity retrieval words: “Xu Beihong” and “Picture of Eight Horses”. Next, by making information retrieval based on the two entity retrieval words, two retrieval results in a sub-graph form may be obtained as below: Picture of Eight Horses (Giuseppe Castiglione) and Picture of Eight Horses (Xu Beihong) (it is to be understood that all information in a knowledge graph is in the form of sub-graphs). Next, non-retrieved information is removed by performing entity disambiguation by means of sub-graph matching to obtain sub-graph information corresponding to Picture of Eight Horses (Xu Beihong). The final answer is obtained by means of text similarity matching between entity information and the to-be-answered question.

Next, solutions of this embodiment of the present disclosure are described in detail with reference to specific steps.

The to-be-answered question refers to a question for obtaining the corresponding answer from the knowledge graph.

In some examples, the to-be-answered question may be a question inputted by a user. For example, when user A needs to obtain an answer to a certain question, the user A may input a corresponding question in the knowledge graph, such that the user A may obtain the corresponding to-be-answered question.

In some examples, the to-be-answered question may also be a question obtained from the Internet. For example, it may be obtained questions in which the user is interested, and a question in which the user is more interested is determined as the to-be-answered question.

It is to be understood that the above examples are merely examples enumerated for better understanding the technical solutions of this embodiment of the present disclosure. In specific implementation, other methods may also be adopted to obtain the to-be-answered question. This embodiment of the present disclosure does not impose any restriction on the methods for obtaining the to-be-answered question.

Step 202 is performed after the to-be-answered question is obtained.

Step 202: inputting the to-be-answered question into a first network model for text recognition.

The first network model is a model for performing text recognition on the to-be-answered question. In the present disclosure, the first network model may be a bert model, etc.

After the to-be-answered question is obtained, the to-be-answered question may be inputted into the first network model, such that the first network model performs text recognition on the to-be-answered question.

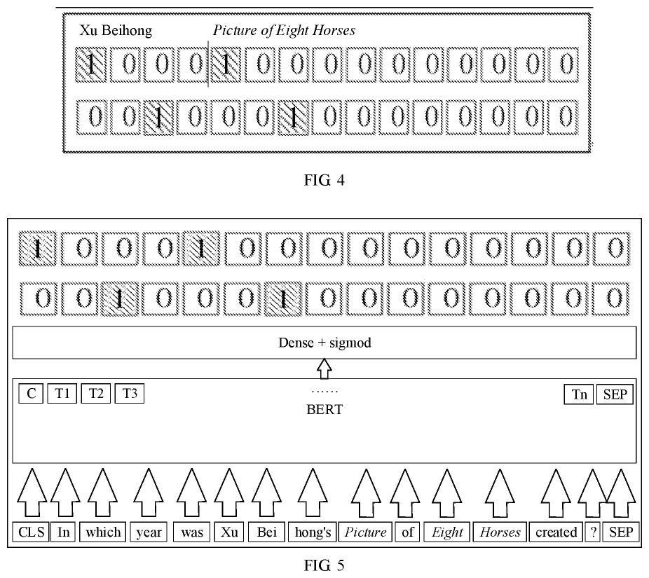

In the present disclosure, text recognition may be implemented by means of pointer tagging. For example, with reference to FIG. 4, a schematic diagram of an entity tagging sample according to an embodiment of the present disclosure is illustrated. As shown in FIG. 4, starting and ending positions of entities in data may be respectively tagged by means of two sequence tags. FIG. 4 shows manners of tagging “Xu Beihong” and “Picture of Eight Horses” in the question sentence “in which year was Xu Beihong's Picture of Eight Horses created?”

Specifically, the to-be-answered question may be inputted into the first network model by means of single input. As shown in FIG. 5, after the to-be-answered question is inputted into the bert model, the sentence may be encoded as [CLS] in which year was Xu Beihong's Picture of Eight Horses created? [SEP] A code outputted by the BERT model is inputted into a fully-connected layer and is processed by means of a Sigmod activation function. A loss function adopts a binary cross-entropy loss function. A value at each position of the final output sequence is degree of confidence of the starting and ending positions of the entities. Herein positions having a degree of confidence greater than 0.5 are determined as the starting and ending positions of the entities, and the entities can be obtained by intercepting the corresponding position of the original input text.

Step 203 is performed after the to-be-answered question is inputted into the first network model for text recognition.

Step 203: determining starting and ending positions of the to-be-answered question according to a text recognition result.

The starting and ending positions refer to starting and ending positions tagged in the to-be-answered question. The tagged entity words can be determined by means of the tagged starting and ending positions.

After the to-be-answered question is inputted into the first network model for text recognition, the starting and ending positions tagged in the text of the to-be-answered question can be obtained according to the text recognition result. As shown in FIG. 4, entity recognition may be performed by means of pointer tagging, specifically as below. The starting and ending positions of the entities in data are respectively tagged by means of two sequence tags. FIG. 4 shows the manners of tagging “Xu Beihong” and “Picture of Eight Horses” in the question sentence “in which year was Xu Beihong's Picture of Eight Horses created?”

Step 204 is performed after the starting and ending positions of the to-be-answered question are determined according to the text recognition result.

Step 204: determining the at least one entity retrieval word according to the starting and ending positions.

The entity retrieval word refers to an entity word for information retrieval in the to-be-answered question.

After the starting and ending positions of the to-be-answered question are determined, entity words in the to-be-answered question may be recognized according to the starting and ending positions. As shown in FIG. 4, based on the tagged result, the entity words in the to-be-answered question may be obtained as below: “Xu Beihong” and “Picture of Eight Horses”.

Step 205 is performed after the at least one entity retrieval word is obtained based on the text recognition result.

Step 205: retrieving from a preset knowledge base by means of the at least one entity retrieval word to obtain a plurality of initial retrieval texts associated with the at least one entity retrieval word.

In the present disclosure, the preset knowledge base refers to a pre-generated database corresponding to the knowledge graph. In the preset knowledge base, all the information of the knowledge graph may be stored in the database in an associated form to obtain the preset knowledge base. Specifically, associated information may be arranged in sequence by taking a certain entity word as an index in the form of a database list, to form the associated information in the sub-graph form having numerous association relationships.

The initial retrieval text refers to a retrieval text obtained by retrieving from the preset knowledge base by means of the entity retrieval word.

After the at least one entity retrieval word is obtained, a plurality of initial retrieval texts associated with each entity retrieval word may be obtained by retrieving from the preset knowledge base by means of the at least one entity retrieval word.

Step 206 is performed after the plurality of initial retrieval texts associated with the at least one entity retrieval word is obtained by retrieving from the preset knowledge base by means of the at least one entity retrieval word.

Step 206: associating the at least one entity retrieval word with the plurality of initial retrieval texts in the form of sub-graph to obtain the retrieval text in the sub-graph form.

Knowledge graph retrieval is performed by determining a recognized entity as a retrieval word. For example, when retrieving the Picture of Eight Horses, there are two Pictures of Eight Horses in the knowledge base. In this case, attributes and relationships of this entity may be obtained from the knowledge graph. The attributes and the relationships exist in the knowledge graph in the form of sub-graphs, as shown in FIG. 6. To distinguish the “Picture of Eight Horses” in the question sentence is which one of the two Pictures of Eight Horses as shown in FIG. 6, the attributes and the relationships of the entity are connected by “-” to serve as description information of this entity. As shown in FIG. 6, by associating information respectively corresponding to the Picture of Eight Horses (Xu Beihong) and the Picture of Eight Horses (Giuseppe Castiglione), retrieval texts in the sub-graph form respectively corresponding to the two entities can be obtained. For example, the two entities “Picture of Eight Horses” may be respectively described as below: Author (Xu Beihong)_Creation time (Modern times)_Creation category (Ink painting)_genre (Romanticism)_Collection location (Unknown); author (Giuseppe Castiglione)_Creation time (Qing Dynasty)_Creation category (Ink and color on silk)_genre (Court painting)_Collection location (the Palace Museum).

Step 207 is performed after the retrieval text in the sub-graph form is obtained by associating the at least one entity retrieval word with the plurality of initial retrieval texts in the form of sub-graph.

Step 207: composing the retrieval text in the sub-graph form and the to-be-answered question into a sentence pair text.

A sentence pair refers to a pair of sentence texts composed of two texts. For example, two texts are “Xu Beihong” and “Zhang Daqian”, and the sentence pair composed of the two texts is “Xu Beihong-Zhang Daqian”. For another example, two texts are “mountains-and-waters painting” and “landscape painting”, and the sentence pair composed of the two texts is “mountains-and-waters painting-landscape painting”.

The sentence pair text refers to a sentence pair composed of the retrieval text in the sub-graph form and the to-be-answered question. That is, after the retrieval text in the sub-graph form corresponding to each entity retrieval word is obtained, the retrieval text in the sub-graph form and the to-be-answered question compose a sentence pair. In this way, the sentence pair text may be obtained.

Step 208 is performed after the retrieval text in the sub-graph form and the to-be-answered question compose the sentence pair text.

Step 208: inputting the sentence pair text into a second network model.

The second network model refers to a preset network model configured to perform entity disambiguation on the retrieval text in the sub-graph form. The second network model may be a bert model, etc., and specifically, the second network mode may be determined according to business requirements, which is not limited in this embodiment of the present disclosure.

After each retrieval text in the sub-graph form and the to-be-answered question compose the sentence pair text, the sentence pair text may be inputted into the second network model. For example, with reference to the example in Step 207, the sentence pair inputted into the BERT model is encoded as: [CLS] “In which year was Xu Beihong's Picture of Eight Horses created?” [SEP] Author (Xu Beihong)_Creation time (Modern times)_Creation category (Ink painting)_genre (Romanticism)_Collection location (Unknown), the [CLS] “In which year was Xu Beihong's Picture of Eight Horses created?” may be inputted into the bert model, and the inputted problem is processed by means of a dense layer and a sigmod layer.

It is to be understood that the above examples are merely examples enumerated for better understanding the technical solutions of this embodiment of the present disclosure, and are not intended to be the only limitation on this embodiment of the present disclosure.

Step 209 is performed after the sentence pair text is inputted into the second network model.

Step 209: performing entity disambiguation on the sentence pair text by means of the second network model to determine the retrieval text in the target sub-graph form.

The retrieval text in the target sub-graph form refers to a retrieval text in the sub-graph form, selected from the at least one entity retrieval word, that matches the to-be-answered question. That is, in this step, entity disambiguation is implemented to remove the retrieval text in the sub-graph form that does not match the to-be-answered question, such that a final retrieval text matching the to-be-answered question may be obtained, which is the retrieval text in the target sub-graph form.

After the sentence pair text is inputted into the second network model, entity disambiguation may be performed on the sentence pair text by means of the second network model. Specifically, semantic analysis recognition may be performed on the retrieval text in the sub-graph form and the to-be-answered question, to recognize the retrieval text in the target sub-graph form matching the to-be-answered question. For example, with reference to FIG. 7, a schematic diagram of a bert-based sub-graph matching algorithm according to an embodiment of the present disclosure is illustrated. As shown in FIG. 7, after a sentence pair text composed of each retrieval text in the sub-graph form and the to-be-answered question is obtained, the sentence pair text may be inputted into the second network model, such that the second network model determines, according to descriptions of the to-be-answered question and the entity, the retrieval text in the target sub-graph form matching the to-be-answered question.

Step 210 is performed after the retrieval text in the target sub-graph form is determined by performing entity disambiguation on the sentence pair text by means of the second network model.

Step 210: disassembling the retrieval text in the target sub-graph form to obtain the at least one candidate answer.

The candidate answer refers to a candidate item, selected from the retrieval text in the target sub-graph form, as an answer to the to-be-answered question.

After a sub-graph (i.e., the retrieval text in the target sub-graph form) of a core entity in the question is determined, to further determine an answer, it is required to disassemble the sub-graph of the core entity according the relationships and the attributes, such that at least one candidate answer may be obtained. For example, with reference to FIG. 8, a schematic diagram of disassembling a sub-graph according to an embodiment of the present disclosure is illustrated. As shown in FIG. 8, after the left figure of FIG. 8 is disassembled, a plurality of candidate items as shown in the right figure of FIG. 8 may be obtained as below: author of the Picture of Eight Horses: Xu Beihong, creation time of the Picture of Eight Horses: modern times, collection location of the Picture of Eight Horses: unknown, genre of the Picture of Eight Horses: romanticism, and creation category of the Picture of Eight Horses: ink painting, etc.

It is to be understood that the above examples are merely examples enumerated for better understanding the technical solutions of this embodiment of the present disclosure, and are not intended to be the only limitation on this embodiment of the present disclosure.

Step 211 or Step 213 is performed after the at least one candidate answer is obtained by disassembling the retrieval text in the target sub-graph form.

Step 211: inputting the at least one candidate answer and the to-be-answered question into a third network model.

The third network model refers to a model configured to calculate the similarity between the candidate answer and the to-be-answered question. The third network model may be a bert model, etc. Specifically, the third network model may be determined according to business requirements, which is not limited in this embodiment of the present disclosure.

After the at least one candidate answer is obtained, the at least one candidate answer and the to-be-answered question may be inputted into the third network model.

Step 212 is performed after the at least one candidate answer and the to-be-answered question are inputted into the third network model.

Step 212: performing similarity matching on the at least one candidate answer and the to-be-answered question by means of the third network model to determine the similarity between the at least one candidate answer and the to-be-answered question.

The similarity refers to degree of similarity between the at least one candidate answer and the to-be-answered question. The similarity can reflect which candidate answers are closer to the to-be-answered question, and those candidate answers closer to the to-be-answered question can be determined as standard answers to the to-be-answered question.

After the at least one candidate answer and the to-be-answered question are inputted into the third network model, similarity calculation may be performed on the at least one candidate answer by means of the third network model. For example, with reference to FIG. 9, a schematic diagram of text similarity matching according to an embodiment of the present disclosure is illustrated. As shown in FIG. 9, a question sentence (i.e., the to-be-answered question) and relationship/attribute description (i.e., a candidate answer) may be inputted into the BERT model, and similarity matching between the at least one candidate answer and the to-be-answered question is performed by means of the BERT model, such that the similarity between the at least one candidate answer and the to-be-answered question may be obtained.

Step 213 inputting the at least one candidate answer and the to-be-answered question into a cosine similarity calculation model.

Step 214 is performed after the at least one candidate answer and the to-be-answered question are inputted into the cosine similarity calculation model.

Step 214: performing similarity matching on the at least one candidate answer and the to-be-answered question by means of the cosine similarity calculation model to determine the similarity between the at least one candidate answer and the to-be-answered question.

It is to be understood that in specific implementation, the similarity between each candidate answer and the to-be-answered question may be calculated by means of a method for calculating a cosine similarity, which is not limited in this embodiment of the present disclosure.

The three models mentioned in the above steps of the embodiments of the present disclosure may be obtained by means of joint learning. That is, in all the three tasks mentioned above, the pre-trained BERT model from Google serves as a feature extractor. For this reason, it is considered to implement the three tasks by means of joint learning. Herein, the entity recognition task is referred to as Task A, the sub-graph matching task is referred to as Task B, and the text similarity matching task is referred to as Task C. To unify the loss function, a cosine similarity objective function in the Task C may be changed to the binary cross-entropy loss function. An objective function for joint learning is minimized loss=loss_TaskA+loss_TaskB+loss_TaskC. In the present disclosure, three key tasks (i.e., the entity recognition task, the entity disambiguation task, and the text matching task) are implemented simultaneously by means of joint learning. This method neither requires introduction of external corpuses nor requires construction of templates, and thus flexibility and efficiency of the question answering system can be improved.

Step 104c is performed after the similarity between the at least one candidate answer and the to-be-answered question is determined by performing similarity matching on the at least one candidate answer and the to-be-answered question by means of the third network model.

Step 104c: determining a target answer to the to-be-answered question from the at least one candidate answer according to the similarity.

The target answer refers to the standard answer to the to-be-answered question selected from the at least one candidate answer. That is, the finally selected target answer is determined as an accurate answer to the to-be-answered question.

This Step 104c may include following Steps 104d and 104f.

Step 104d: comparing the similarity with a preset similarity threshold.

Step 104f: obtaining, form the at least one candidate answer, an answer where the similarity is greater than the similarity threshold, and determining the answer as the target answer.

Specifically, a similarity threshold for comparison with the similarity of at least one candidate answer may be preset by business personnel. A specific value of the similarity threshold may be determined according to business requirements, which is not limited in this embodiment of the present disclosure. After the similarity between the at least one candidate answer and the to-be-answered question is obtained by calculation, the target answer to the to-be-answered question may be selected from the at least one candidate answer in combination with the similarity of the at least one candidate answer. That is, a candidate answer whose similarity is greater than the similarity threshold is selected from the at least one candidate answer, and the candidate answer whose similarity is greater than the similarity threshold is determined as the target answer.

In this embodiment of the present disclosure, entity disambiguation is performed by means of sub-graph matching, it is not required to construct templates, and thus information retrieval efficiency of the question answering system can be improved.

The method for information acquisition provided by this embodiment of the present disclosure includes: recognizing at least one entity retrieval word in a to-be-answered question; performing information retrieval according to the at least one entity retrieval word to obtain a retrieval text in a sub-graph form corresponding to the at least one entity retrieval word; determining a retrieval text in a target sub-graph form by matching the retrieval text in the sub-graph form with the to-be-answered question; determining at least one candidate answer corresponding to the to-be-answered question according to the retrieval text in the target sub-graph form; obtaining a similarity between the at least one candidate answer and the to-be-answered question; and determining the target answer to the to-be-answered question from the at least one candidate answer according to the similarity. In this embodiment of the present disclosure, entity disambiguation is performed by means of sub-graph matching, and simultaneously three key tasks are achieved, i.e., entity recognition, entity disambiguation, and text matching. This method neither requires introduction of external corpuses nor requires construction of templates, and thus flexibility and efficiency of the question answering system can be improved.

With reference to FIG. 11, a schematic structural diagram of an apparatus for information acquisition according to an embodiment of the present disclosure is illustrated. The apparatus for information acquisition may include following modules:

an entity retrieval word recognizing module 310, configured to recognize at least one entity retrieval word in a to-be-answered question;

a sub-graph retrieval text obtaining module 320, configured to perform information retrieval according to the at least one entity retrieval word to obtain a retrieval text in a sub-graph form corresponding to the at least one entity retrieval word;

a target sub-graph text determining module 330, configured to determine a retrieval text in a target sub-graph form by matching the retrieval text in the sub-graph form with the to-be-answered question; and

a target answer determining module 340, configured to determine a target answer to the to-be-answered question according to the retrieval text in the target sub-graph form.

The apparatus for information acquisition provided by this embodiment of the present disclosure is configured to: recognize at least one entity retrieval word in a to-be-answered question, perform information retrieval according to the at least one entity retrieval word to obtain a retrieval text in a sub-graph form corresponding to the at least one entity retrieval word, determine a retrieval text in a target sub-graph form by matching the retrieval text in the sub-graph form with the to-be-answered question, and determine a target answer to the to-be-answered question according to the retrieval text in the target sub-graph form. In this embodiment of the present disclosure, entity disambiguation is performed by means of sub-graph matching, and simultaneously three key tasks are achieved, i.e., entity recognition, entity disambiguation, and text matching. This method neither requires introduction of external corpuses nor requires construction of templates, and thus flexibility and efficiency of the question answering system can be improved.

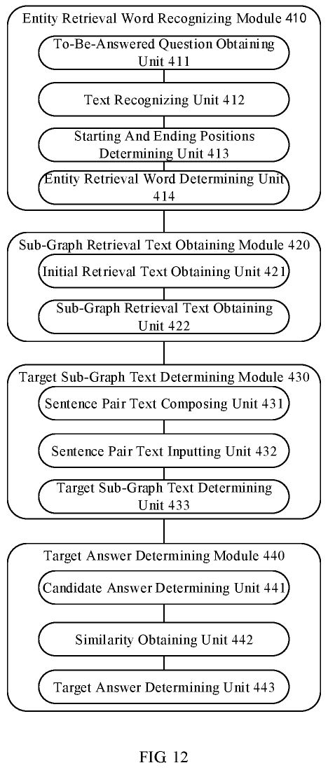

With reference to FIG. 12, a schematic structural diagram of an apparatus for information acquisition according to an embodiment of the present disclosure is illustrated. The apparatus for information acquisition may include following modules:

an entity retrieval word recognizing module 410, configured to recognize at least one entity retrieval word in a to-be-answered question;

a sub-graph retrieval text obtaining module 420, configured to perform information retrieval according to the at least one entity retrieval word to obtain a retrieval text in a sub-graph form corresponding to the at least one entity retrieval word;

a target sub-graph text determining module 430, configured to determine a retrieval text in a target sub-graph form by matching the retrieval text in the sub-graph form with the to-be-answered question; and

a target answer determining module 440, configured to determine a target answer to the to-be-answered question according to the retrieval text in the target sub-graph form.

Optionally, the target answer determining module 440 includes:

a candidate answer determining unit 441, configured to determine at least one candidate answer corresponding to the to-be-answered question according to the retrieval text in the target sub-graph form;

a similarity obtaining unit 442, configured to obtain a similarity between the at least one candidate answer and the to-be-answered question; and

a target answer determining unit 443, configured to determine the target answer to the to-be-answered question from the at least one candidate answer according to the similarity.

Optionally, the entity retrieval word recognizing module 410 includes:

a to-be-answered question obtaining unit 411, configured to obtain the to-be-answered question;

a text recognizing unit 412, configured to input the to-be-answered question into a first network model for text recognition;

a starting and ending positions determining unit 413, configured to determine starting and ending positions of the to-be-answered question according to a text recognition result; and

an entity retrieval word determining unit 414, configured to determine the at least one entity retrieval word according to the starting and ending positions.

Optionally, the sub-graph retrieval text obtaining module 420 includes:

an initial retrieval text obtaining unit 421, configured to obtain a plurality of initial retrieval texts associated with the at least one entity retrieval word by retrieving from a preset knowledge base by means of the at least one entity retrieval word; and

a sub-graph retrieval text obtaining unit 422, configured to obtain the retrieval text in the sub-graph form by associating the at least one entity retrieval word with the plurality of initial retrieval texts in the form of sub-graph.

Optionally, the target sub-graph text determining module 430 includes:

a sentence pair text composing unit 431, configured to compose the retrieval text in the sub-graph form and the to-be-answered question into a sentence pair text;

a sentence pair text inputting unit 432, configured to input the sentence pair text into a second network model; and

a target sub-graph text determining unit 433, configured to determine the retrieval text in the target sub-graph form by performing entity disambiguation on the sentence pair text by means of the second network model.

Optionally, the candidate answer determining unit 441 includes:

a candidate answer obtaining subunit 4411, configured to obtain the at least one candidate answer by disassembling the retrieval text in the target sub-graph form.

Optionally, the similarity obtaining unit 442 includes:

a first candidate answer inputting subunit 4421, configured to input the at least one candidate answer and the to-be-answered question into a third network model; and

a first similarity determining subunit 4422, configured to determine the similarity between the at least one candidate answer and the to-be-answered question by performing similarity matching on the at least one candidate answer and the to-be-answered question by means of the third network model.

Optionally, the similarity obtaining unit 442 includes:

a second candidate answer inputting subunit 4423, configured to input the at least one candidate answer and the to-be-answered question into a cosine similarity calculation model; and

a second similarity determining subunit 4424, configured to determine the similarity between the at least one candidate answer and the to-be-answered question by performing similarity matching on the at least one candidate answer and the to-be-answered question by means of the cosine similarity calculation model.

Optionally, the target answer determining unit 443 includes:

a similarity comparison subunit 4431, configured to compare the similarity with a preset similarity threshold; and

a target answer obtaining subunit 4432, configured to obtain, form the at least one candidate answer, an answer where the similarity is greater than the similarity threshold, and to determine the answer as the target answer.

The apparatus for information acquisition provided by this embodiment of the present disclosure is configured to: recognize at least one entity retrieval word in a to-be-answered question, perform information retrieval according to the at least one entity retrieval word to obtain a retrieval text in a sub-graph form corresponding to the at least one entity retrieval word, determine a retrieval text in a target sub-graph form by matching the retrieval text in the sub-graph form with the to-be-answered question, determine at least one candidate answer corresponding to the to-be-answered question according to the retrieval text in the target sub-graph form, obtain a similarity between the at least one candidate answer and the to-be-answered question, and determine the target answer to the to-be-answered question from the at least one candidate answer according to the similarity. In this embodiment of the present disclosure, entity disambiguation is performed by means of sub-graph matching, and simultaneously three key tasks are achieved, i.e., entity recognition, entity disambiguation, and text matching. This method neither requires introduction of external corpuses nor requires construction of templates, and thus flexibility and efficiency of the question answering system can be improved.

For a brief description, the foregoing method embodiments are described as a combination of a series of motions. However, those skilled in the art should know that the present disclosure is not limited by sequences of the motions described. This is because some steps may be performed by using other sequences or be performed simultaneously in accordance with the present disclosure. In addition, those skilled in the art should also learn that the embodiments described in the specification are preferred embodiments, and involved motions and modules are not necessary for the present disclosure.

In addition, an embodiment of the present disclosure also provides an electronic device, which includes a processor, a memory, and a computer program stored in the memory and executed by the processor. The computer program is executable by the processor, whereby any one of the above methods for information acquisition is implemented.

An embodiment of the present disclosure also provides a nonvolatile computer-readable storage medium. Instructions in the storage medium are executable by a processor of an electronic device, whereby the electronic device is caused to perform any one of the above methods for information acquisition.

Apparatus embodiments set forth above are merely exemplary, wherein units described as detached parts may be or not be detachable physically; parts displayed as units may be or not be physical units, i.e., either located at the same place, or distributed on a plurality of network units. Modules may be selected in part or in whole according to actual needs to achieve objectives of the solution of this embodiment. Those of ordinary skill in the art may comprehend and implement the embodiment without contributing creative effort.

Each of the device embodiments of the present disclosure can be implemented by hardware, or implemented by software modules operating on one or more processors, or implemented by the combination thereof. A person skilled in the art should understand that, in practice, a microprocessor or a digital signal processor (DSP) may be employed to realize some or all of the functions of some or all of the parts in the electronic device according to the embodiments of the present disclosure. The present disclosure may further be implemented as device or apparatus program (for example, computer program and computer program product) for executing some or all of the methods as described herein. Such program for implementing the present disclosure may be stored in the computer readable medium, or have a form of one or more signals. Such a signal may be downloaded from the Internet websites, or be provided on a carrier signal, or provided in any other form.

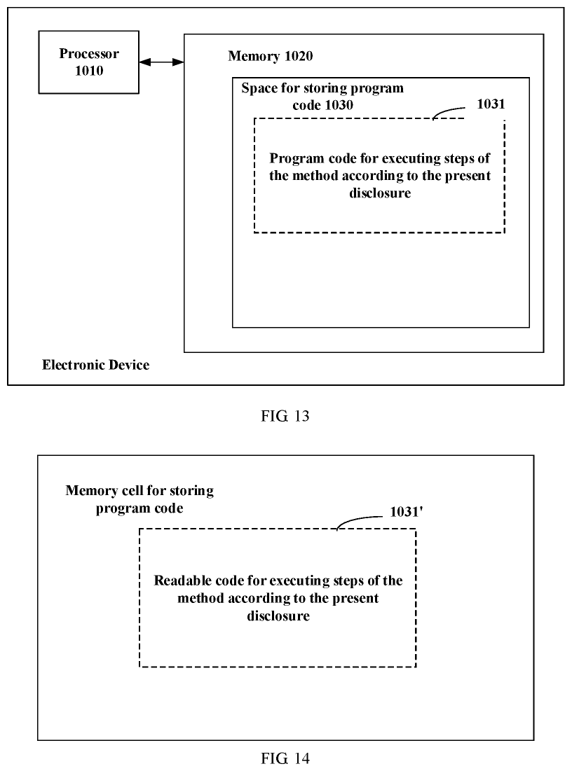

For example, FIG. 13 illustrates an electronic device that may implement the method according to the present disclosure. Traditionally, the electronic device comprises a processor 1010 and a computer program product or a computer readable medium in form of a memory 1020. The memory 1020 may be electronic memories such as flash memory, EEPROM (Electrically Erasable Programmable Read-Only Memory), EPROM, hard disk or ROM. The memory 1020 has a memory space 1030 for executing program codes 1031 of any steps in the above methods. For example, the memory space 1030 for program codes may comprise respective program codes 1031 for implementing the respective steps in the method as mentioned above. These program codes may be read from and/or be written into one or more computer program products. These computer program products include program code carriers such as hard disk, compact disk (CD), memory card or floppy disk. These computer program products generally are the portable or stable memory cells as shown in reference FIG. 14. The memory cells may be provided with memory sections, memory spaces, etc., similar to the memory 1020 of the electronic device as shown in FIG. 13. The program codes may be compressed for example in an appropriate form. Generally, the memory cell includes computer readable codes 1031′ which can be read for example by processors 1010. When these codes are operated on the electronic device, the electronic device may be caused to perform respective steps in the method as described above.

The embodiments in the specification are described in a progressive manner. Each embodiment is focused on difference from other embodiments. And cross reference is available for identical or similar parts among different embodiments.

Finally it should be explained that a relational term (such as a first or a second . . . ) is merely intended to separate one entity or operation from another entity or operation instead of requiring or hinting any practical relation or sequence exists among these entities or operations. Furthermore, terms such as “comprise”, “include” or other variants thereof are intended to cover a non-exclusive “comprise” so that a process, a method, a merchandise or a device comprising a series of elements not only includes these elements, but also includes other elements not listed explicitly, or also includes inherent elements of the process, the method, the merchandise or the device. In the case of no more restrictions, elements restricted by a sentence “include a . . . ” do not exclude the fact that additional identical elements may exist in a process, a method, a merchandise or a device of these elements.

Detailed introduction to a method for information acquisition, an apparatus for information acquisition, an electronic device, and a nonvolatile computer-readable storage medium provided by the present disclosure is made hereinabove, elaboration of the principles and embodiments of the present disclosure is made with reference to specific examples herein, and description of the foregoing embodiments is merely intended to assist in understanding the method of the present disclosure and a core concept thereof. Also, those of ordinary skill in the art may change, in according with the core concept of the present disclosure, embodiments and scope of application. In conclusion, contents of this specification shall not be interpreted as limiting the present disclosure.

1. A method for information acquisition, wherein the method comprises:
recognizing at least one entity retrieval word in a to-be-answered question;
performing information retrieval according to the at least one entity retrieval word to obtain a retrieval text in a sub-graph form corresponding to the at least one entity retrieval word;
determining a retrieval text in a target sub-graph form by matching the retrieval text in the sub-graph form with the to-be-answered question; and
determining a target answer to the to-be-answered question according to the retrieval text in the target sub-graph form.

2. The method according to claim 1, wherein the determining a target answer to the to-be-answered question according to the retrieval text in the target sub-graph form comprises:
determining at least one candidate answer corresponding to the to-be-answered question according to the retrieval text in the target sub-graph form;
obtaining a similarity between the at least one candidate answer and the to-be-answered question; and
determining the target answer to the to-be-answered question from the at least one candidate answer according to the similarity.

3. The method according to claim 1, wherein the recognizing at least one entity retrieval word in a to-be-answered question comprises:
obtaining the to-be-answered question;
inputting the to-be-answered question into a first network model for text recognition;
determining starting and ending positions of the to-be-answered question according to a text recognition result; and
determining the at least one entity retrieval word according to the starting and ending positions.

4. The method according to claim 1, wherein the performing information retrieval according to the at least one entity retrieval word to obtain a retrieval text in a sub-graph form corresponding to the at least one entity retrieval word comprises:
retrieving from a preset knowledge base by means of the at least one entity retrieval word to obtain a plurality of initial retrieval texts associated with the at least one entity retrieval word; and
associating the at least one entity retrieval word with the plurality of initial retrieval texts in the form of sub-graph to obtain the retrieval text in the sub-graph form.

5. The method according to claim 1, wherein the determining a retrieval text in a target sub-graph form by matching the retrieval text in the sub-graph form with the to-be-answered question comprises:
composing the retrieval text in the sub-graph form and the to-be-answered question into a sentence pair text;
inputting the sentence pair text into a second network model; and
performing entity disambiguation on the sentence pair text by means of the second network model to determine the retrieval text in the target sub-graph form.

6. The method according to claim 2, wherein the determining at least one candidate answer corresponding to the to-be-answered question according to the retrieval text in the target sub-graph form comprises:
disassembling the retrieval text in the target sub-graph form to obtain the at least one candidate answer.

7. The method according to claim 2, wherein the obtaining a similarity between the at least one candidate answer and the to-be-answered question comprises:
inputting the at least one candidate answer and the to-be-answered question into a third network model; and
performing similarity matching on the at least one candidate answer and the to-be-answered question by means of the third network model to determine the similarity between the at least one candidate answer and the to-be-answered question.

8. The method according to claim 2, wherein the obtaining a similarity between the at least one candidate answer and the to-be-answered question comprises:
inputting the at least one candidate answer and the to-be-answered question into a cosine similarity calculation model; and
performing similarity matching on the at least one candidate answer and the to-be-answered question by means of the cosine similarity calculation model to determine the similarity between the at least one candidate answer and the to-be-answered question.

9. The method according to claim 2, wherein the determining the target answer to the to-be-answered question from the at least one candidate answer according to the similarity comprises:
comparing the similarity with a preset similarity threshold; and
obtaining, form the at least one candidate answer, an answer where the similarity is greater than the similarity threshold, and determining the answer as the target answer.

10. (canceled)

11. (canceled)

12. (canceled)

13. (canceled)

14. (canceled)

15. (canceled)

16. (canceled)

17. (canceled)

18. (canceled)

19. An electronic device, wherein the electronic device comprises:
a processor, a memory, and a computer program stored in the memory and executed by the processor, wherein the computer program is executable by the processor, performing the operations comprising:
recognizing at least one entity retrieval word in a to-be-answered question;
performing information retrieval according to the at least one entity retrieval word to obtain a retrieval text in a sub-graph form corresponding to the at least one entity retrieval word;
determining a retrieval text in a target sub-graph form by matching the retrieval text in the sub-graph form with the to-be-answered question; and
determining a target answer to the to-be-answered question according to the retrieval text in the target sub-graph form.

20. A nonvolatile computer-readable storage medium, wherein instructions in the storage medium are executable by a processor of an electronic device, whereby the electronic device is configured to perform operations comprising:
recognizing at least one entity retrieval word in a to-be-answered question;
performing information retrieval according to the at least one entity retrieval word to obtain a retrieval text in a sub-graph form corresponding to the at least one entity retrieval word;
determining a retrieval text in a target sub-graph form by matching the retrieval text in the sub-graph form with the to-be-answered question; and
determining a target answer to the to-be-answered question according to the retrieval text in the target sub-graph form.

21. A computer program product, wherein the computer program product comprises a computer-readable code, wherein when the computer-readable code runs on an electronic device, the electronic device is caused to perform the method for information acquisition according to claim 1.

22. The electronic device according to claim 19, wherein the operation of determining a target answer to the to-be-answered question according to the retrieval text in the target sub-graph form comprises:
determining at least one candidate answer corresponding to the to-be-answered question according to the retrieval text in the target sub-graph form;
obtaining a similarity between the at least one candidate answer and the to-be-answered question; and
determining the target answer to the to-be-answered question from the at least one candidate answer according to the similarity.

23. The electronic device according to claim 19, wherein the operation of recognizing at least one entity retrieval word in a to-be-answered question comprises:
obtaining the to-be-answered question;
inputting the to-be-answered question into a first network model for text recognition;
determining starting and ending positions of the to-be-answered question according to a text recognition result; and
determining the at least one entity retrieval word according to the starting and ending positions.

24. The electronic device according to claim 19, wherein the operation of performing information retrieval according to the at least one entity retrieval word to obtain a retrieval text in a sub-graph form corresponding to the at least one entity retrieval word comprises:
retrieving from a preset knowledge base by means of the at least one entity retrieval word to obtain a plurality of initial retrieval texts associated with the at least one entity retrieval word; and
associating the at least one entity retrieval word with the plurality of initial retrieval texts in the form of sub-graph to obtain the retrieval text in the sub-graph form.

25. The electronic device according to claim 19, wherein the operation of determining a retrieval text in a target sub-graph form by matching the retrieval text in the sub-graph form with the to-be-answered question comprises:
composing the retrieval text in the sub-graph form and the to-be-answered question into a sentence pair text;
inputting the sentence pair text into a second network model; and
performing entity disambiguation on the sentence pair text by means of the second network model to determine the retrieval text in the target sub-graph form.

26. The storage medium according to claim 20, wherein the operation of determining a target answer to the to-be-answered question according to the retrieval text in the target sub-graph form comprises:
determining at least one candidate answer corresponding to the to-be-answered question according to the retrieval text in the target sub-graph form;
obtaining a similarity between the at least one candidate answer and the to-be-answered question; and
determining the target answer to the to-be-answered question from the at least one candidate answer according to the similarity.

27. The storage medium according to claim 20, wherein the operation of recognizing at least one entity retrieval word in a to-be-answered question comprises:
obtaining the to-be-answered question;
inputting the to-be-answered question into a first network model for text recognition;
determining starting and ending positions of the to-be-answered question according to a text recognition result; and
determining the at least one entity retrieval word according to the starting and ending positions.

28. The storage medium according to claim 20, wherein the operation of performing information retrieval according to the at least one entity retrieval word to obtain a retrieval text in a sub-graph form corresponding to the at least one entity retrieval word comprises:
retrieving from a preset knowledge base by means of the at least one entity retrieval word to obtain a plurality of initial retrieval texts associated with the at least one entity retrieval word; and
associating the at least one entity retrieval word with the plurality of initial retrieval texts in the form of sub-graph to obtain the retrieval text in the sub-graph form.

29. The storage medium according to claim 20, wherein the operation of determining a retrieval text in a target sub-graph form by matching the retrieval text in the sub-graph form with the to-be-answered question comprises:
composing the retrieval text in the sub-graph form and the to-be-answered question into a sentence pair text;
inputting the sentence pair text into a second network model; and
performing entity disambiguation on the sentence pair text by means of the second network model to determine the retrieval text in the target sub-graph form.
